(19) United States
(12) Patent Application Publication
(10) Pub. No.: US 2016/0378551 A1
(43) Pub. Date: Dec. 29, 2016

(54) ADAPTIVE HARDWARE ACCELERATION BASED ON RUNTIME POWER EFFICIENCY DETERMINATIONS

(71) Applicant: Intel Corporation, Santa Clara, CA (US)

(72) Inventors: Priya N. Vaidya, Shrewsbury, MA (US); Premanand Sakarda, Acton, MA (US)

(73) Assignee: Intel Corporation, Santa Clara, CA (US)

(21) Appl. No.: 14/748,515

(22) Filed: Jun. 24, 2015

(51) Int. Cl. G06F 9/48

(52) U.S. Cl. CPC G06F 9/4893

(57) ABSTRACT

Systems and methods may provide for making a power efficiency determination at runtime based on one or more runtime usage notifications and scheduling a workload for execution on a hardware accelerator if the power efficiency determination indicates that execution of the workload on the hardware accelerator will be more efficient than execution of the workload on a host processor. Additionally, the workload may be scheduled for execution on the host processor if the power efficiency determination indicates that execution of the workload on the host processor will be more efficient than execution of the workload on the hardware accelerator. In one example, making the power efficiency determination includes applying one or more configurable rules to at least one of the one or more runtime usage notifications.

### TECHNICAL FIELD

Embodiments generally relate to power management. More particularly, embodiments relate to adaptive hardware acceleration based on runtime power efficiency determinations.

### BACKGROUND

Heterogeneous computing systems may use central processing units (CPUs) as well as hardware accelerators to handle workloads. Typically, the accelerator, which may include a relatively large number of processor cores, may have the fixed role of performing parallel data processing. The CPU, on the other hand, may have the fixed role of performing non-parallel data processing such as sequential code execution or data transfer management. Such a work distribution may be power inefficient for all types of workloads because for some workloads it may underutilize the CPU, be limited to single CPU-accelerator combinations, and waste time transferring data between accelerators and CPUs.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a workload distribution solution according to an embodiment;

FIGS. 2-3 are charts of examples of power state residencies for usage models according to embodiments;

FIG. 4 is a flowchart of an example of a method of operating power efficiency logic according to an embodiment;

FIG. 5 is a block diagram of an example of an operating system architecture according to an embodiment; and

FIG. 6 is a block diagram of an example of a computing system according to an embodiment.

### DESCRIPTION OF EMBODIMENTS

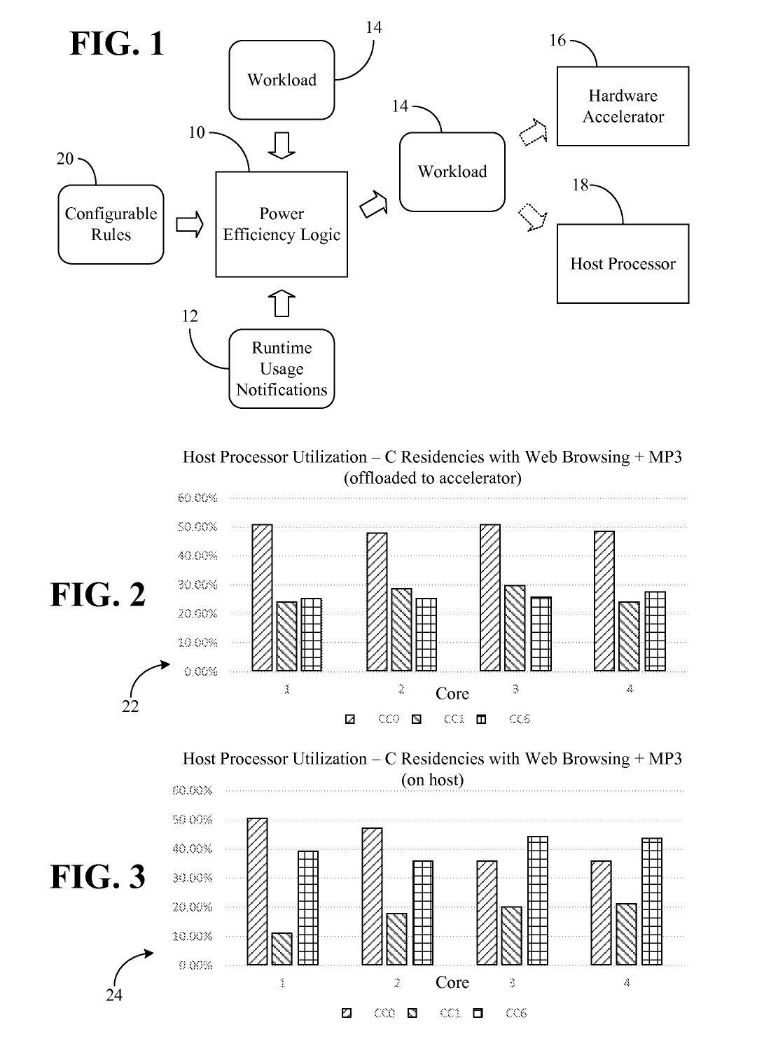

Turning now to FIG. 1, a workload distribution solution is shown in which power efficiency logic 10 makes power efficiency determinations at runtime based on one or more runtime usage notifications 12 (e.g., hints from a power hardware abstraction layer/HAL, not shown). The runtime usage notifications 12 may indicate the presence of, for example, user interaction activity, video encoding activity, video decoding activity, web browsing activity, touch boost activity (e.g., increased processor frequency due to consecutive touch screen events), etc., or any combination thereof, in a computing system. The power efficiency logic 10 may generally apply one or more configurable rules 20 to the runtime usage notifications 12 in order to determine whether to schedule a workload 14 for execution on a hardware accelerator 16 (e.g., audio digital signal processor/DSP, sensor, graphics processor, etc.) or on a host processor 18 (e.g., central processing unit/CPU).

Table I below shows one example of a set of rules 20 that might be configured and/or used by the power efficiency logic 10 when the workload 14 is audio content (e.g., received from an audio driver) that may be selectively “tunneled” to the hardware accelerator 16 (e.g., a DSP) for further processing.

TABLE I

| Hint | Flag | Rule |
|---|---|---|
| Interaction | Yes or No | Yes → Disable DSP tunneling |
| Video Encoding or Decoding | Yes or No | Yes → Disable DSP tunneling |
| Low power and No interaction | Yes or No | No → Enable DSP tunneling |
| Web browsing | Yes or No | Yes → Disable DSP tunneling |
| Touch boost | Yes or No | Yes →Disable DSP tunneling |

Thus, in the first item listed in Table I, the hint for user interaction activity being in the “yes” state may indicate that execution of the workload 14 on the host processor 18 will be more power efficient than execution of the workload 14 on the hardware accelerator 16. Such a condition may arise due to the host processor 18 already being active as well as the host processor 18 being performance competitive with the hardware accelerator 16 for the particular type of workload 14. On the other hand, in the third item listed in Table I, the hints for low power and no user interaction being in the “no” state may indicate that execution of the workload 14 on the hardware accelerator 16 will be more power efficient than execution of the workload 14 on the host processor 18. This condition may arise due to power losses associated with bringing the host processor 18 out of the low power state. Additionally, there may be power losses associated with bringing the rest of the SoC (system on chip) out of the low power state. Other rules and notifications may be used, depending on the circumstances. Moreover, the rules may be dynamically configured/adapted at runtime to achieve a more flexible solution.

FIGS. 2 and 3 generally demonstrate the advantages that may be achieved through the use of adaptive hardware acceleration based on runtime power efficiency determinations. More particularly, FIG. 2 shows a first chart 22 that quantifies C-state residencies for four different processor cores while web browsing and audio playback (e.g., MP3/MPEG-1 or MPEG-2 Audio Layer III) to a hardware accelerator is taking place (e.g., with DSP tunneling enabled). By contrast, FIG. 3 shows a second chart 24 that quantifies C-state residencies for the same four processor cores while web browsing and audio playback to a host processor is taking place (e.g., with DSP tunneling disabled). In the illustrated example, the C-states are the CC0, CC1 and CC6 ACPI (Advanced Configuration and Power Interface, e.g., ACPI Specification, Rev. 5.0a, Dec. 6, 2011) states, wherein the CCO state is a relatively shallow state with higher power consumption than the CC6 state, which is relatively deep with low power consumption. Relative to the chart 22, the chart 24 exhibits both a decrease in the time spent in the CCO state (e.g., Core #3 decreased by 13% and Core #4 decreased by 8%) and an increase in the time spent in the CC6 state (e.g., Core #1 increased by 14%, Core #2 increased by 12.7%, Core #3 increased by 18.5%, and Core #4 increased by 16%). Thus, disabling DSP tunneling during audio playback may be more power efficient when web browsing is taking place on the system. The values provided herein are to facilitate discussion and may vary depending on the circumstances.

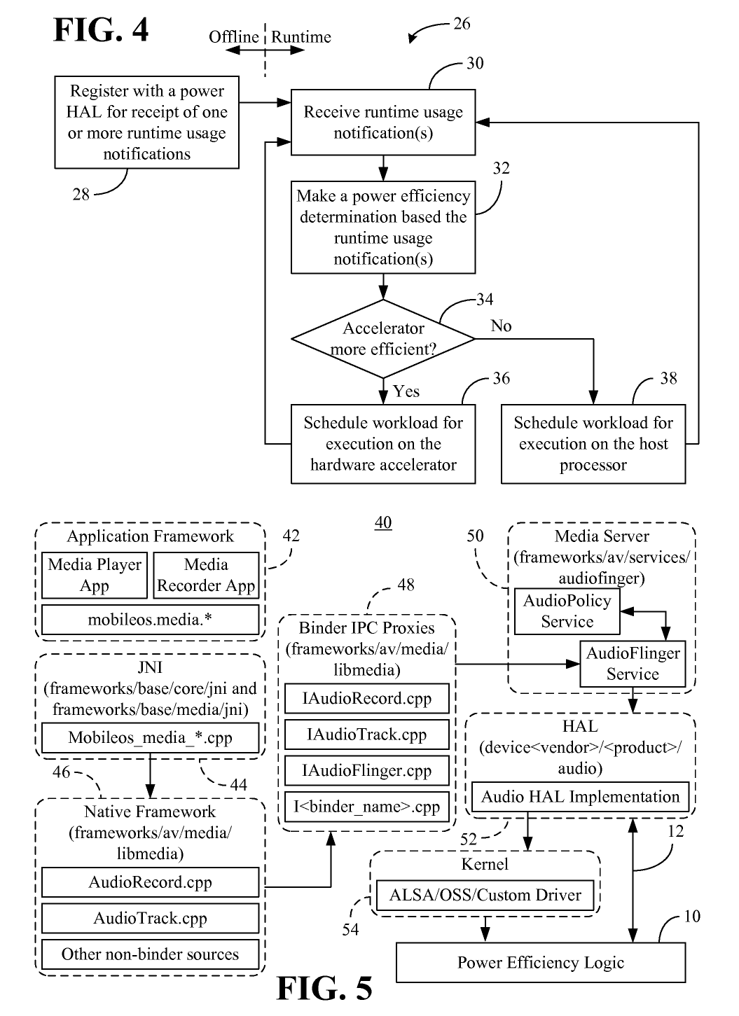

FIG. 4 shows a method 26 of operating power efficiency logic such as, for example, the power efficiency logic 10 (FIG. 1), already discussed. The method 26 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 26 may be written in any combination of one or more programming languages, including an object oriented programming language such as JAVA, SMALLTALK, C++ or the like and conventional procedural programming languages, such as the “C” programming language or similar programming languages.

Illustrated processing block 28 provides for registering with a power hardware access layer (HAL) for receipt of one or more runtime usage notifications (e.g., user interaction hints, video encoding hints, video decoding hints, web browsing hints, touch boost hints, etc.). Block 28 may be conducted offline (e.g., prior to runtime). One or more runtime usage notifications may be received at block 30, wherein illustrated block 32 makes a power efficiency determination based on at least one of the runtime usage notification(s). Block 32 may include applying one or more configurable rules to the runtime usage notification(s). Block 32 may also provide for configuring one or more of the rules at runtime. A determination may be made at block 34 as to whether the power efficiency determination indicates that execution of a workload on a hardware accelerator will be more efficient than execution of the workload on a host processor. If so, the workload may be scheduled for execution on the hardware accelerator at block 36. If, on the other hand, the power efficiency determination indicates that that execution of the workload on the host processor will be more efficient than execution of the workload on the hardware accelerator, block 38 may schedule the workload for execution on the host processor.

FIG. 5 shows an operating system (OS) architecture 40. The architecture 40 may generally be part of a system on chip (SoC) in an electronic device/platform having computing functionality (e.g., personal digital assistant/PDA, notebook computer, tablet computer, server), communications functionality (e.g., wireless smart phone), imaging functionality, media playing functionality (e.g., smart television/TV), wearable functionality (e.g., watch, eyewear, headwear, footwear, jewelry), vehicular functionality (e.g., car, truck, motorcycle), etc., or any combination thereof. In the illustrated example, the architecture 40 includes an application framework 42, a native interface (e.g., JAVA Native Interface/JNI) 44, a native framework 46, a set of binder inter process communication (IPC) proxies 48, a media server 50, a HAL 52, and a kernel 54.

The dotted line components in FIG. 5 may be software components such as, for example, ANDROID/LINUX components. For example, the application framework 42 may use media APIs (application programming interfaces) to interface with the audio and/or video subsystem. Additionally, the binder IPC proxies 48 may facilitate communications across different processes. The APIs may be implemented as classes to access the native code that interfaces with the audio codec. The media server 50 may provide audio services that interface with an audio HAL implementation in the HAL 52, which defines standard services and interfaces to an audio driver (e.g., Advanced LINUX Sound Architecture/ALSA and/or Open Sound System/OSS custom driver) in the kernel 54. The implementation of the HAL 52 may be device specific, wherein the audio driver interfaces with the actual audio hardware and is responsible for enabling DSP tunneling.

The HAL 52 may therefore send the runtime usage notifications 12 to the power efficiency logic 10, which may accept workloads from the kernel 54 and automatically determine whether to schedule the workloads for execution on a hardware accelerator or a host processor.

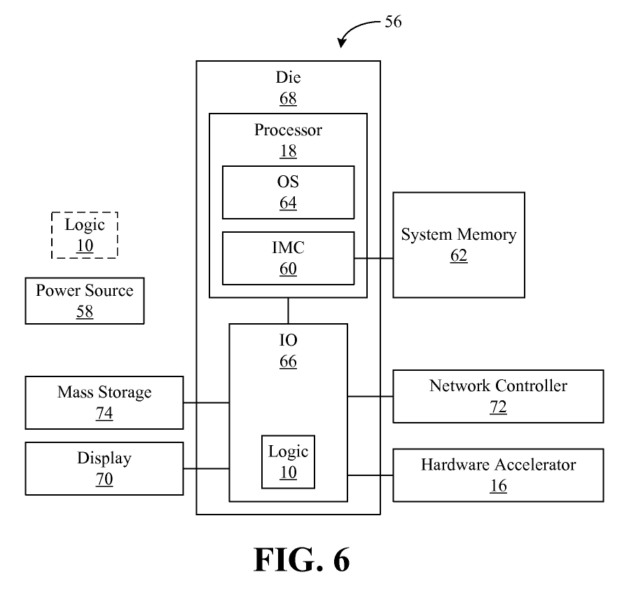

FIG. 6 shows a computing system 56. The computing system 56 may also be part of an electronic device/platform having computing functionality, communications functionality, imaging functionality, media playing functionality, wearable functionality, vehicular functionality, etc., or any combination thereof. In the illustrated example, the system 56 includes a power source 58 to supply power to the system 56 and a processor 18 having an integrated memory controller (IMC) 60, which may communicate with system memory 62. The system memory 62 may include, for example, dynamic random access memory (DRAM) configured as one or more memory modules such as, for example, dual inline memory modules (DIMMs), small outline DIMMs (SODIMMs), etc. The processor 18 may execute an operating system (OS) 64 similar to the OS architecture 40 (FIG. 5), already discussed.

The illustrated system 56 also includes an input output (IO) module 66 implemented together with the processor 18 on a semiconductor die 68 as a system on chip (SoC), wherein the IO module 66 functions as a host device and may communicate with, for example, a display 70 (e.g., touch screen, liquid crystal display/LCD, light emitting diode/LED display), a network controller 72, the hardware accelerator 16, and mass storage 74 (e.g., hard disk drive/HDD, optical disk, flash memory, etc.). The illustrated IO module 66 may include the logic 10 that makes power efficiency determinations at runtime based on runtime usage notifications and automatically decides whether to execute workloads on the processor 18 or the hardware accelerator 16 based on the power efficiency determinations. Thus, the logic 10 may perform one or more aspects of the method 26 (FIG. 4), already discussed.

Additional Notes and Examples:

Example 1 may include an adaptive computing system comprising a hardware accelerator, a host processor, and logic, implemented at least partly in one or more of configurable logic or fixed functionality logic hardware, to make a power efficiency determination at runtime based on one or more runtime usage notifications, schedule a workload for execution on the hardware accelerator if the power efficiency determination indicates that execution of the workload on the hardware accelerator will be more efficient than execution of the workload on the host processor, and schedule the workload for execution on the host processor if the power efficiency determination indicates that execution of the workload on the host processor will be more efficient than execution of the workload on the hardware accelerator.

Example 2 may include the system of Example 1, wherein the logic is to apply one or more configurable rules to at least one of the one or more runtime usage notifications.

Example 3 may include the system of Example 2, wherein the logic is to configure at least one of the one or more configurable rules at runtime.

Example 4 may include the system of Example 1, wherein the logic is to register with a power hardware access layer for receipt of the one or more runtime usage notifications, and wherein the one or more usage notifications are to indicate one or more of user interaction activity, video encoding activity, video decoding activity, web browsing activity or touch boost activity.

Example 5 may include the system of any one of Examples 1 to 4, wherein the workload is to include an audio playback workload.

Example 6 may include the system of any one of Examples 1 to 4, wherein the hardware accelerator includes one or more of an audio digital signal processor, a sensor or a graphics accelerator.

Example 7 may include a power efficiency apparatus comprising logic, implemented at least partly in one or more of configurable logic or fixed functionality logic hardware, to make a power efficiency determination at runtime based on one or more runtime usage notifications, schedule a workload for execution on a hardware accelerator if the power efficiency determination indicates that execution of the workload on the hardware accelerator will be more efficient than execution of the workload on a host processor, and schedule the workload for execution on the host processor if the power efficiency determination indicates that execution of the workload on the host processor will be more efficient than execution of the workload on the hardware accelerator.

Example 8 may include the apparatus of Example 7, wherein the logic is to apply one or more configurable rules to at least one of the one or more runtime usage notifications.

Example 9 may include the apparatus of Example 8, wherein the logic is to configure at least one of the one or more configurable rules at runtime.

Example 10 may include the apparatus of Example 7, wherein the logic is to register with a power hardware access layer for receipt of the one or more runtime usage notifications, and wherein the one or more usage notifications are to indicate one or more of user interaction activity, video encoding activity, video decoding activity, web browsing activity or touch boost activity.

Example 11 may include the apparatus of any one of Examples 7 to 10, wherein the workload is to include an audio playback workload.

Example 12 may include the apparatus of any one of Examples 7 to 10, wherein the hardware accelerator is to include one or more of an audio digital signal processor, a sensor or a graphics accelerator.

Example 13 may include a method of operating a power efficiency apparatus, comprising making a power efficiency determination at runtime based on one or more runtime usage notifications, scheduling a workload for execution on a hardware accelerator if the power efficiency determination indicates that execution of the workload on the hardware accelerator will be more efficient than execution of the workload on a host processor, and scheduling the workload for execution on the host processor if the power efficiency determination indicates that execution of the workload on the host processor will be more efficient than execution of the workload on the hardware accelerator.

Example 14 may include the method of Example 13, wherein making the power efficiency determination includes applying one or more configurable rules to at least one of the one or more runtime usage notifications.

Example 15 may include the method of Example 14, further including configuring at least one of the one or more configurable rules at runtime.

Example 16 may include the method of Example 13, further including registering with a power hardware access layer for receipt of the one or more runtime usage notifications, wherein the one or more usage notifications indicate one or more of user interaction activity, video encoding activity, video decoding activity, web browsing activity or touch boost activity.

Example 17 may include the method of any one of Examples 13 to 16, wherein the workload includes an audio playback workload.

Example 18 may include the method of any one of Examples 13 to 16, wherein the hardware accelerator includes one or more of an audio digital signal processor, a sensor or a graphics accelerator.

Example 19 may include at least one computer readable storage medium comprising a set of instructions, which when executed by a computing device, cause the computing device to make a power efficiency determination at runtime based on one or more runtime usage notifications, schedule a workload for execution on a hardware accelerator if the power efficiency determination indicates that execution of the workload on the hardware accelerator will be more efficient than execution of the workload on a host processor, and schedule the workload for execution on the host processor if the power efficiency determination indicates that execution of the workload on the host processor will be more efficient than execution of the workload on the hardware accelerator.

Example 20 may include the at least one computer readable storage medium of Example 19, wherein the instructions, when executed, cause a computing device to apply one or more configurable rules to at least one of the one or more runtime usage notifications.

Example 21 may include the at least one computer readable storage medium of Example 20, wherein the instructions, when executed, cause a computing device to configure at least one of the one or more configurable rules at runtime.

Example 22 may include the at least one computer readable storage medium of Example 19, wherein the instructions, when executed, cause a computing device to register with a power hardware access layer for receipt of the one or more runtime usage notifications, and wherein the one or more usage notifications are to indicate one or more of user interaction activity, video encoding activity, video decoding activity, web browsing activity or touch boost activity.

Example 23 may include the at least one computer readable storage medium of any one of Examples 19 to 22, wherein the workload is to include an audio playback workload.

Example 24 may include the at least one computer readable storage medium of any one of Examples 19 to 22, wherein the hardware accelerator is to include one or more of an audio digital signal processor, a sensor or a graphics accelerator.

Example 25 may include a power efficiency apparatus comprising means for making a power efficiency determination at runtime based on one or more runtime usage notifications; means for scheduling a workload for execution on a hardware accelerator if the power efficiency determination indicates that execution of the workload on the hardware accelerator will be more efficient than execution of the workload on a host processor; and means for scheduling the workload for execution on the host processor if the power efficiency determination indicates that execution of the workload on the host processor will be more efficient than execution of the workload on the hardware accelerator.

Example 26 may include the apparatus of Example 25, wherein the means for making the power efficiency determination includes means for applying one or more configurable rules to at least one of the one or more runtime usage notifications.

Example 27 may include the apparatus of Example 26, further including means for configuring at least one of the one or more configurable rules at runtime.

Example 28 may include the apparatus of Example 25, further including means for registering with a power hardware access layer for receipt of the one or more runtime usage notifications, wherein the one or more usage notifications are to indicate one or more of user interaction activity, video encoding activity, video decoding activity, web browsing activity or touch boost activity.

Example 29 may include the apparatus of any one of Examples 25 to 28, wherein the workload is to include an audio playback workload.

Example 30 may include the apparatus of any one of Examples 25 to 28, wherein the hardware accelerator is to include one or more of an audio digital signal processor, a sensor or a graphics accelerator.

Techniques described herein may therefore enable better utilization of host processor capacity. Additionally, the techniques may be extended beyond single CPU-accelerator combinations to more complex SoCs having multiple CPUs and/or multiple accelerators. For example, high performance computing (HPC) systems and multi-player game applications may achieve greater power efficiency. Moreover, time spent transferring data between accelerators and CPUs may be minimized and fixed roles regarding data parallelism may be eliminated. Simply put, work distribution may be more power efficient using techniques described herein.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A system comprising:
a hardware accelerator;
a host processor; and
logic, implemented at least partly in one or more of configurable logic or fixed functionality logic hardware, to:
make a power consumption determination at runtime based on one or more runtime usage notifications,
schedule a workload for execution on the hardware accelerator if the power consumption determination indicates that execution of the workload on the hardware accelerator will be more efficient than execution of the workload on the host processor, and
schedule the workload for execution on the host processor if the power consumption determination indicates that execution of the workload on the host processor will be more efficient than execution of the workload on the hardware accelerator.

2. The system of claim 1, wherein the logic is to apply one or more configurable rules to at least one of the one or more runtime usage notifications.

3. The system of claim 2, wherein the logic is to configure at least one of the one or more configurable rules at runtime.

4. The system of claim 1, wherein the logic is to register with a power hardware access layer for receipt of the one or more runtime usage notifications, and wherein the one or more usage notifications are to indicate one or more of user interaction activity, video encoding activity, video decoding activity, web browsing activity or touch boost activity.

5. The system of claim 1, wherein the workload is to include an audio playback workload.

6. The system of claim 1, wherein the hardware accelerator includes one or more of an audio digital signal processor, a sensor or a graphics accelerator.

7. An apparatus comprising:
logic, implemented at least partly in one or more of configurable logic or fixed functionality logic hardware, to:
make a power consumption determination at runtime based on one or more runtime usage notifications;
schedule a workload for execution on a hardware accelerator if the power consumption determination indicates that execution of the workload on the hardware accelerator will be more efficient than execution of the workload on a host processor; and
schedule the workload for execution on the host processor if the power consumption determination indicates that execution of the workload on the host processor will be more efficient than execution of the workload on the hardware accelerator.

8. The apparatus of claim 7, wherein the logic is to apply one or more configurable rules to at least one of the one or more runtime usage notifications.

9. The apparatus of claim 8, wherein the logic is to configure at least one of the one or more configurable rules at runtime.

10. The apparatus of claim 7, wherein the logic is to register with a power hardware access layer for receipt of the one or more runtime usage notifications, and wherein the one or more usage notifications are to indicate one or more of user interaction activity, video encoding activity, video decoding activity, web browsing activity or touch boost activity.

11. The apparatus of claim 7, wherein the workload is to include an audio playback workload.

12. The apparatus of claim 7, wherein the hardware accelerator is to include one or more of an audio digital signal processor, a sensor or a graphics accelerator.

13. A method comprising:
making a power consumption determination at runtime based on one or more runtime usage notifications;
scheduling a workload for execution on a hardware accelerator if the power consumption determination indicates that execution of the workload on the hardware accelerator will be more efficient than execution of the workload on a host processor; and
scheduling the workload for execution on the host processor if the power consumption determination indicates that execution of the workload on the host processor will be more efficient than execution of the workload on the hardware accelerator.

14. The method of claim 13, wherein making the power consumption determination includes applying one or more configurable rules to at least one of the one or more runtime usage notifications.

15. The method of claim 14, further including configuring at least one of the one or more configurable rules at runtime.

16. The method of claim 13, further including registering with a power hardware access layer for receipt of the one or more runtime usage notifications, wherein the one or more usage notifications indicate one or more of user interaction activity, video encoding activity, video decoding activity, web browsing activity or touch boost activity.

17. The method of claim 13, wherein the workload includes an audio playback workload.

18. The method of claim 13, wherein the hardware accelerator includes one or more of an audio digital signal processor, a sensor or a graphics accelerator.

19. At least one non-transitory computer readable storage medium comprising a set of instructions, which when executed by a computing device, cause the computing device to:
make a power consumption determination at runtime based on one or more runtime usage notifications;
schedule a workload for execution on a hardware accelerator if the power consumption determination indicates that execution of the workload on the hardware accelerator will be more efficient than execution of the workload on a host processor; and
schedule the workload for execution on the host processor if the power consumption determination indicates that execution of the workload on the host processor will be more efficient than execution of the workload on the hardware accelerator.

20. The at least one non-transitory computer readable storage medium of claim 19, wherein the instructions, when executed, cause a computing device to apply one or more configurable rules to at least one of the one or more runtime usage notifications.

21. The at least one non-transitory computer readable storage medium of claim 20, wherein the instructions, when executed, cause a computing device to configure at least one of the one or more configurable rules at runtime.

22. The at least one non-transitory computer readable storage medium of claim 19, wherein the instructions, when executed, cause a computing device to register with a power hardware access layer for receipt of the one or more runtime usage notifications, and wherein the one or more usage notifications are to indicate one or more of user interaction activity, video encoding activity, video decoding activity, web browsing activity or touch boost activity.

23. The at least one non-transitory computer readable storage medium of claim 19, wherein the workload is to include an audio playback workload.

24. The at least one non-transitory computer readable storage medium of claim 19, wherein the hardware accelerator is to include one or more of an audio digital signal processor, a sensor or a graphics accelerator.
